(19) United States
(12) Patent Application Publication
(10) Pub. No.: US 2018/0247722 A1
(43) Pub. Date: Aug. 30, 2018

(54) TRANSPARENT CONDUCTORS

(71) Applicant: The Regents of the University of California, Oakland, CA (US)

(72) Inventors: Peidong Yang, Kensington, CA (US); Letian Dou, El Ceririto, CA (US); Fan Cui, Berkeley, CA (US)

(21) Appl. No.: 15/754,192

(22) PCT Filed: Sep. 15, 2016
(86) PCT No.: PCT/US2016/051889

§ 371 Date: Feb. 21, 2018

Related U.S. Application Data
(60) Provisional application No. 62/219,358, filed on Sep. 16, 2015.

(51) Int. Cl. H01B 1/02; H01B 1/08; H01B 1/04; B22F 1/00; B22F 1/02

(52) U.S. Cl. CPC H01B 1/02; H01B 1/08; G02F 1/13439; B22F 1/0044; B22F 1/02; H01B 1/04

(57) ABSTRACT

The disclosure provides for transparent conductors comprised of metal-reduced graphene oxide or graphene core-shell nanowires, process of preparation thereof, and methods of use thereof.

### CROSS REFERENCE TO RELATED APPLICATIONS

This application claims priority under 35 U.S.C. § 119 from U.S. Provisional Application Ser. No. 62/219,358 filed Sep. 16, 2015, the disclosure of which is incorporated herein by reference.

### TECHNICAL FIELD

The disclosure provides for transparent conductors comprised of metal-reduced graphene oxide or graphene core-shell nanowires, process of preparation thereof, and methods of use thereof.

### BACKGROUND

Transparent conducting electrodes play an important role in many optoelectronic devices, such as displays (LCD & LED), photovoltaic devices, touch panels, and electrochromic windows. Although indium-tin-oxide (ITO) has been widely used in industry for a long time, several concerns are raised recently. For example, ITO is relatively expensive, brittle (not compatible with flexible substrates), and it shows strong absorption in the near-IR region, which is not ideal for solar cell and photodetector applications.

### SUMMARY

Disclosed herein is an innovative approach to wrap GO nanosheets around or attach to the surface of metal nanowires (NWs). In further embodiments, the obtained GO coated nanowires can be annealed under mild thermal conditions or by using plasma-based approaches, and then reduced using a graphene oxide reducing agent. Examples of graphene oxide reducing agents include, but are not limited to, chemical reducing agents (e.g., hydrazine), heating under a reducing atmosphere, and photo-thermal reduction. Using the methods disclosed herein, high quality metal-rGO core-shell NWs can be obtained. The disclosure also provides for high performance transparent conducting films comprising the core-shell nanowires disclosed herein. The conducting films described herein exhibited excellent optical and electric performance under tested conditions. Further, these conducting films were highly stable, and perform as well as ITO and silver NW thin films. The disclosure further provides for electrodes comprising the conducting films of the disclosure for a variety of electronic devices.

In a particular embodiment, the disclosure provides a method to synthesize nanowires comprising a metal nanowire core and a graphene or graphene oxide shell, comprising: adding a solution comprising metal nanowires in a first solvent to a solution comprising graphene oxide nanosheets or graphene nanoribbons in a second solvent in order to form a mixture; agitating the mixture (e.g., by using ultrasonfication) to form metal nanowires that comprise a shell or coating of graphene oxide or graphene, wherein the first solvent and the second solvent may be the same solvent or alternatively, different solvents. In a further embodiment, the first solvent is a nonpolar solvent. Examples of nonpolar solvents include, but are not limited to, toluene, pentane, cyclopentane, hexane, cyclohexane, heptane, ligroin, benzene, 1,4-dioxane, chloroform, carbon tetrachloride, diethyl ether, dichloromethane, xylene, methyl-tert-butyl ether, and any mixture thereof. In yet a further embodiment, the second solvent is a polar protic solvent and/or a polar aprotic solvent. Examples of polar aprotic solvents include, but are not limited to, tetrahydrofuran, ethyl acetate, acetone, dimethylformamide, acetonitrile, dimethyl sulfoxide, and any mixture thereof. Examples of polar protic solvents include, but are not limited to, ammonia, formic acid, n-butanol, t-butanol, n-propanol, isopropanol, nitromethane, ethanol, methanol, acetic acid, water, and any mixture thereof. In a particular embodiment, the polar protic solvent comprises an alcohol.

In a further embodiment, a method to synthesize nanowires comprising a metal nanowire core and a graphene or graphene oxide shell described herein further comprises: purifying the nanowires by: (i) dispersing the nanowires in a polar solvent; and (ii) collecting the nanowires by centrifugation; wherein steps (i) and (ii) can be repeated one or more times. Examples of polar solvents include, but are not limited to, tetrahydrofuran, ethyl acetate, acetone, dimethylformamide, acetonitrile, dimethyl sulfoxide, ammonia, formic acid, n-butanol, t-butanol, n-propanol, isopropanol, nitromethane, ethanol, methanol, acetic acid, water, and any mixture thereof. In a particular embodiment the polar solvent is isopropanol. In a further embodiment, the nanowires described herein can be collected by centrifugation or filtration.

In a certain embodiment, metal nanowires comprise diameters between 1 nm up to 1 μm are produced using the synthesis methods disclosed herein. In another embodiment, the metal nanowires disclosed herein can be comprised of silicon, germanium, copper, aluminum, tin, zinc, nickel, iron, titanium, chromium, vanadium, manganese, cobalt, silver, gold, and platinum. In a particular embodiment, the metal nanowires disclosed herein are comprised of copper. In a further embodiment, the copper nanowires have an average diameter between 2 nm to 30 nm.

In a certain embodiment, the disclosure also provides that the graphene oxide nanosheets or graphene nanoribbons disclosed herein have diameters between 2 nm to 50 nm. In a particular embodiment, the graphene oxide nanosheets have an average diameter of about 10 nm. In another embodiment, the ratio by weight of metal nanowires to graphene nanosheets or graphene nanoribbons is 1:20 to 20:1. In a further embodiment, the ratio by weight of metal nanowires to graphene nanosheets or graphene nanoribbons is 1:10 to 10:1. In yet a further embodiment, the ratio by weight of metal nanowires to graphene nanosheets or graphene nanoribbons is about 1:1.

In another embodiment, the disclosure provides a method to synthesize nanowires comprising a metal nanowire core and a graphene or graphene oxide shell described herein which further comprises: reducing the coating of graphene oxide on the nanowire to reduced graphene oxide by using a chemical, thermal, photothermal, or electrochemical reduction process.

In a particular embodiment, the disclosure further provides that the coated nanowires produced by the methods disclosed herein are characterized by having a diameter less than 50 nanometers and having a coating of graphene oxide, reduced graphene oxide, or graphene of around 1 to 10 nm, and wherein the nanowire has an aspect ratio greater than 1.

In a certain embodiment, the disclosure provides for a nanowire comprising: a core of copper that is 10 to 21 nm in diameter; and a shell of graphene oxide, reduced graphene oxide, or graphene that is 1 to 10 nm in thickness, wherein the shell is in contact along the length dimension of the copper core and wherein the nanowire has an aspect ratio greater than 1.

In another embodiment, the disclosure also provides a method to produce a conducting film of annealed nanowires, comprising: (A) forming a network of nanowires disclosed herein on a substrate; (B) annealing the network of nanowires by using plasma-based approach or by annealing at temperature between 200° C. to 300° C.; and if the coating is graphene oxide, (C) reducing the annealed network of nanowires in the presence of a graphene oxide reducing agent so as to form a conducting film comprising an annealed network of nanowires comprising a metal nanowire core and a reduced graphene oxide coating, wherein the graphene oxide reducing agent is selected from (i) a reducing atmosphere comprising hydrogen; (ii) one or more chemical agents selected from hydrazine, lithium naphthalenide, sodium naphthalenide, potassium naphthalenide, thiourea dioxide, NaHSO₃, sodium borohydride, lithium aluminum hydride, thiophene, and/or ascorbic acid; and/or (iii) exposure to strong light, and wherein (B) and (C) can be performed as a single reaction step as opposed to two separate steps, when the annealing is done at temperature between 200 to 300° C. and the reducing agent is (i) or (iii). In a further embodiment, the network of nanowires is formed on a substrate by: filtering down a dispersion of nanowires onto a polytetrafluoroethylene porous membrane to from a network of nanowires; and transferring the network of nanowires from the membrane to a substrate by applying pressure to backside of the membrane and forcing intimate contact between the network of nanowires to the substrate. In another embodiment, the substrate is glass. In yet another embodiment, the network of nanowires are annealed at temperature of about 260° C. under an atmosphere comprising argon and hydrogen. In a particular embodiment, the disclosure provides for a conducting film produced by a method disclosed herein. In a further embodiment, the disclosure also provides for a transparent electrode comprising a conducting film disclosed herein. In yet a further embodiment, the disclosure further provides for an optoelectronic device comprising a transparent electrode disclosed herein. Examples of optoelectronic devices include, but are not limited to, LCD displays, a LED displays, photovoltaic devices, touch panels, solar panels, light emitting diodes (LEDs), organic light emitting diode (OLEDs), OLED displays, and electrochromic windows.

### DESCRIPTION OF DRAWINGS

FIG. 1 provides an illustration of the graphene oxide wrapping, film deposition, and reduction process to fabricate transparent conducting films.

FIG. 2 presents a transmission electron microscope (TEM) image showing GO nanosheets with diameters of ˜10 nm.

FIG. 3A-K provides for the structural characterization of the copper-graphene oxide core-shell nanowires. (A) Images showing the nanowire suspension stability. Left: Cu NWs in toluene; Middle: Cu NWs in IPA; Right: Cu GO core-shell NWs in IPA. (B) After 20 min. (C) After 24 hours. (D) A TEM image the Cu GO core-shell nanowire. Scale bar: 50 nm. (E) A high-resolution TEM image the Cu GO core-shell nanowire. Scale bar: 5 nm. (F) FTIR spectra of the Cu nanowires before and after GO wrapping. (G-K) EDS analysis of a core-shell nanowire showing the elemental distribution of copper, carbon, oxygen, and the combination of the three elements. Scale bars: 40 nm.

FIG. 4A-C presents TEM images of the copper nanowires before GO wrapping (A) and with different GO loading amount, (B) 10:1 (w:w) and (C) 1:1 (w:w).

FIG. 5 provides a scheme demonstrating the film fabrication process.

FIG. 6A-B presents the optical and electrical performance of the nanowire-based transparent conducting films. (A) Transmittance spectra of the films from UV to near-IR and corresponding optical images (inset). (B) Transmittance versus the sheet resistance of different type of films.

FIG. 7 demonstrates the sheet resistance of the core-shell NW film at different annealing temperatures. All the films have a similar transparency of ˜85% (at 500 nm).

FIG. 8A-D presents scanning electron microscopy of the films annealed at different temperatures. (A) 200° C., (B) 260° C., (C) 300° C., and (D) 350° C.

FIG. 9A-D presents an experiment demonstrating the thermal reduction of GO. (A) Optical images, (B) FTIR spectra, (C) X-ray diffraction, and (D) X-ray photoelectron spectroscopy studies showing the GO before and after annealing at 260° C.

FIG. 10A-C demonstrates the stability of the nanowire-based transparent conducting films. (A) Different types of films tracked at room temperature in air. The values are an average from 5 individual samples for each type of films. (B) Different types of films tracked at 80° C. in air. (C) The Cu r-GO films showing long term stability in air after storage for 210 days.

FIG. 11A-D shows haze of the nanowire-based transparent conducting films at 550 nm. (A) Experimental data of the haze values of Cu NW films with and without r-GO coating. (B) Nanowire bundle diameter distribution of the conducting films after annealing at the optimized conditions (counted from SEM images with 3 nm Au coated). (C) Simulation of light scattering cross section of a Cu NW coated with a thin graphene layer over variable thickness. (D) Simulation of haze (at 550 nm) versus transmittance for the nanowire films using Cu NW coated with a thin graphene layer over variable thickness.

FIG. 12A-B shows TEM images of the Cu r-GO core-shell NW after thermal annealing at 260° C. with 10% H2 in Ar for 30 min. (A) a lower magnification view. (B) a higher magnification view.

FIG. 13A-C shows AFM images of the annealed Cu r-GO core-shell NW films. The bars indicate the thickness of individual wires and junctions.

FIG. 14 shows stability of Cu NW and Cu r-GO NW thin films in high humidity and high temperature environment (temperature=80° C., humidity=80±5%).

FIG. 15A-B shows (A) and illustration of the light scattering effects in a core-shell nanowire. (B) shows a simulation result of the angular-dependent far field light scattering of the core-shell nanowire with different graphene coating thickness.

FIG. 16 shows Cu r-GO Transmission versus wavelength for three samples with sheet resistance=40 (top plot), 8.6 (middle plot), and 3.4 (bottom plot) Ohm/sq. The decrease in transmission is in agreement with experimental data. Note the maximum in transmission at ˜650 nm.

FIG. 17 shows a simulated transmittance (at 550 nm) versus the sheet resistance for Cu and Cu r-GO nanowire films.

### DETAILED DESCRIPTION

As used herein and in the appended claims, the singular forms “a,” “and,” and “the” include plural referents unless the context clearly dictates otherwise. Thus, for example, reference to “a nanowire” includes a plurality of such nanowires and reference to “the conductor” includes reference to one or more conductors or equivalents thereof known to those skilled in the art, and so forth.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

Unless defined otherwise, all technical and scientific terms used herein have the same meaning as commonly understood by one of ordinary skill in the art to which this disclosure belongs. Although many methods and reagents similar to or equivalent to those described herein can be used in the practice of the disclosed methods and compositions, the exemplary methods and materials are now described.

All publications mentioned herein are incorporated herein by reference in their entirety for the purposes of describing and disclosing methodologies that might be used in connection with the description herein. With respect to any term that is presented in the publications that is similar to, or identical with, a term that has been expressly defined in this disclosure, the definition of the term as expressly provided in this disclosure will control in all respects.

Intense research efforts have been devoted to the development ITO replacements for next generation electronics. Among them, metal nanowire (NW) films hold great promise for low-cost transparent electrode applications because of their excellent electrical and optical properties, as well as their solution-processibility. As the most conductive material, silver is one of the best choices. Silver nanowires with an average diameter of ˜100 nm and an average length of ˜100 μm have been successfully synthesized. Highly transparent and conductive Ag NW based thin films have been fabricated and a small sheet resistance of ˜20 Ohms/sq with a transmittance of ˜90% (at 550 nm) were achieved, which is close to the commercial ITO substrates. Nevertheless, two problems remain. First, silver is an expensive metal and the material cost is high. Second, the diameter of the Ag NW is large (˜100 nm) and therefore, the light scattering effect is strong. The thick wires lead to large haze values and the pixels behind the transparent conductor become blurry, which is not ideal for display applications. Alternatively, copper nanowires can be good candidates for transparent conductors.

Copper has a conductivity value similar to silver; it is 20 times cheaper than silver; and the synthesis of ultra-thin Cu NWs with an average diameter as low as 17 nm has been demonstrated. Fairly good optical and electrical performance was also obtained for the Cu NW based transparent films by a number of groups. However, thin Cu NWs are intrinsically unstable under ambient conditions. Rapid surface oxidation of the Cu NWs reduces the conductivity dramatically, preventing the real application of such transparent electrodes. To improve the stability of the Cu NWs films, several approaches have been examined. For example, over-growth of a layer of Ni on Cu NWs, or coating the Cu NWs with a very thin layer of Al₂O₃ by atomic layer deposition, etc. Although the stability indeed improved, either the total transparency or the overall conductivity of the films decreased significantly. To maintain the high optical transparency and good electrical conductivity, coating or wrapping a very thin conformal layer of conductive and chemically stable material on the surface of the Cu NWs is desired. Recently, graphene coating on Cu NWs has been proposed to solve this issue. By studying a single wire model, it was found that the graphene coating could improve not only the stability, but also the electric and thermal conductivity of the Cu NWs. To achieve this goal, a plasma enhanced chemical vapor deposition method has been used to grow a thin layer of graphene on Cu NWs. These plasma-based procedures utilize high temperatures during the deposition (˜600° C.). Such procedures, however, are less than ideal for ultra-thin Cu NWs (e.g., see FIG. 8D) and are better suited for thicker nanowires. Although there are embodiments directed to the production of very thin nanowires, it should be readily understood that the methods presented herein can also be used to fabricate much thicker nanowires wires (i.e., wires up to 1 micron in diameter). Moreover, the techniques for wrapping graphene oxide or graphene around the metal nanowires disclosed herein can be used with nanowires of varying thickness, such as ultra-thin nanowires to much thicker nanowires (i.e., wires up to 1 micron in diameter). Therefore, various annealing methods can be used with the metal nanowires disclosed herein, including those that are more advantageous for ultra-thin Cu-nanowires, such as mild thermal approaches, while others may better suited for thicker nanowires, such as plasma-based approaches.

In certain embodiments, the disclosure provides a solution-based method that is capable of producing high quality ultra-thin metal-reduced graphene oxide or graphene core-shell nanowires. By controlling the surface chemistry, graphene oxide (GO) nanosheets or graphene nanoribbons are wrapped around the Cu NWs surface to form a coating. In a particular embodiment, the GO coating is between 1 to 100 nm, 1 to 50 nm, 1 to 20 nm, 2 to 10 nm, or 3 to 5 nm in thickness.

Additionally, the disclosure also provides methods for fabricating transparent conducting films comprising the core-shell nanowires disclosed. The transparent conducting films exhibit excellent conductivity (e.g., sheet resistance=28 Ohms/sq; transparency=89% at 550 nm). Additionally, the transparent conducting films were found to be very stable, even when exposed to air.

The methods disclosed herein allow for the tuning of the core-shell nanowires to fit specific applications, e.g., the core-shell nanowire composition and/or dimensions can be varied so as to produce nanowires that are ideally suited for particular optoelectronic devices. Examples of such optoelectronic devices include but are not limited to, photovoltaics, LED displays, LED diodes, OLED displays, OLED diodes, touch displays, and electrochromatic windows. Metal nanowires for information displays and other like applications have to be very thin (<30 nm) to keep light scattering (haze) at a minimum, but not too thin to sacrifice conductivity. The very thin core-shell nanowire based films disclosed herein were unexpectedly found to have lower haze values compared to naked Cu nanowires despite having larger diameters from the reduced graphene oxide coating. Accordingly, films comprised of the ultra-thin core-shell nanowires disclosed herein are ideal for use in information display panels and other similar applications. Alternatively, films or conductors comprised of thicker core-shell nanowires are particularly suitable for photovoltaics, LED diodes and OLED diodes, due to the increased light scattering effects. The methods disclosed herein allow for the synthesis of varying sizes of nanowires, including very thin nanowires (e.g., <25 nm) to very thick nanowires (e.g., >900 nm).

It should be further understood, that the approaches described herein can not only be used to coat nanowires of varying thickness, but also can be used to coat various metal or semiconducting nanowires, such as nanowires made from transition metals (e.g., Cu, Ti, V, Cr, Mn, Fe, Co, Ni, and Zn); post transition metals (e.g., Al and Sn); precious metals (e.g., Au, Ag, Pt, and Pd); or semiconductors, such as pure elements like Si, Ge, or Ga; binary semiconducting compounds, such as compounds made from elements Groups III and V (e.g., GaAs), elements of groups II and VI, elements of groups IV and VI, and between different group IV elements (e.g, SiC); and ternary compounds, such as metal oxides and alloys.

The term “nano” in regards to a “nanowire”, “nanosheet”, or other structure, is in reference to the diameter dimension of the wire or structure, whereby a “nanowire” and “nanosheet” has a diameter from ≥1 nm to <1.0 μm.

The term “graphene” as used herein refers to a single layer of carbon atoms that are bonded together in a repeating pattern of hexagons. Graphene is characterized by being an incredibly strong material, an excellent electrical conductor, an excellent heat conductor, very flexible, and transparent. In certain embodiments, the graphene material is in the form of graphene nanoribbons (GNRs). GNRs can be wrapped around the nanowire cores disclosed herein to form a shell. Additionally, “graphene” as used herein can be functionalized with heteroatoms (i.e., introducing impurities) to impart favorable physical and/or chemical characteristics for certain applications. Such functionalization methods, include, photoinduction (see Ju et al., Nature Nanotechnology 9:348-352 (2014)) and chemical modification (see Liu et al., J. Mater. Chem., 21:3335-3345 (2011); Georgakilas et al., Chemical Reviews 112(11):6156-6214 (2012)). Alternatively, graphene can be “doped” by altering the number of electrons surrounding atoms of graphene by using electrical signals (see Baeumer et al., Nature Communications 6:6136 (2015)).

The term “graphene oxide” or “GO” as used herein refers to a material comprised of carbon, oxygen, and hydrogen in variable ratios. In particular embodiments, for the GO material disclosed herein the C:O ratio is between 1.0 and 20.0, between 1.2 and 15.0, between 1.5 and 10.0, between 1.7 and 7.0, between 1.8 and 5.0, between 1.9 and 4.0, between 2.0 and 3.5, or between 2.1 and 2.9. Graphene oxide is obtained by treating graphite with strong oxidizers, and then exfoliating the layers of graphite oxide into flakes of graphene oxide using mechanical (e.g., sonication) or chemical means (e.g., treating with base). Graphene oxide in comparison to graphene and reduced graphene oxide is hydrophilic, and an electrical insulator. “Graphene oxide” as used herein may be functionalized with additional heteroatoms, nanoparticles, organic compounds, polymers, and biomaterials to impart favorable physical and/or chemical characteristics for certain applications. Such functionalization methods typically include chemical modification (see McGrail et al., Chem. Mater. 26(19):5806-5811 (2014)); Li et al., Chem. Mater. 27(12):4298-4310 (2015)); Navaee et al., RSC Adv. 5:59874-59880 (2015)); Zhai et al., Composites Science and Technology 77:87-94 (2013)); Chen et al., Chemical Reviews 112(11):6027-6053 (2012)).

The term “reduced graphene oxide” or “rGO” as used herein refers to reducing graphene oxide (GO) using reducing agents to produce reduced graphene oxide (rGO). “Reduced graphene oxide” generally comprises a material that can be similar or very similar to pristine graphene, depending on the graphene oxide material used and the way the reduction is achieved. In comparison to pristine graphene, rGO may comprise, depending on the reduction method, some ratio of C:O. Pristine graphene, by contrast, does not comprise oxygen atoms. In particular embodiments, for the rGO material disclosed herein the C:O ratio is between 20.0 and 90.0, between 21.0 and 80.0, between 22.0 and 70.0, between 23.0 and 60.0, between 24.0 and 50.0, between 25.0 and 40.0, or between 26.0 and 30.0. Typically, graphene oxide can be reduced to rGO using chemical (e.g., treatment with hydrazine hydrate at 100° C. for 24 hours), thermal (e.g., exposure hydrogen plasma for a few seconds; heating in distilled water at varying degrees for different lengths of time; heating in a furnace), photoreduction (e.g., exposure to strong pulse light) or electrochemical means (e.g., linear sweep voltammetry). Once rGO has been produced, it can be functionalized in a similar manner as described for graphene above.

In various embodiments, the diameter of, for example, a “rod” or “wire” is from 1 nm up to 1 μm, about 1.5-900 nm, about 2-800 nm, about 2.5-700 nm, about 3-600 nm, about 3.5-500 nm, about 4-400 nm, about 4.5-300 nm, about 5-200 nm, about 5.5-100, about 6-50 nm, about 6.5-40 nm, about 7-35 nm, about 7.5-30 nm, about 8-25 nm, about 9-24 nm, about 10-23 nm, about 12-22 nm, about 17-21 nm, about 1 nm, about 1.5 nm, about 2 nm, about 2.5 nm, about 3 nm, about 3.5 nm, about 4 nm, about 4.5 nm, about 5 nm, about 10 nm, about 15 nm, about 17 nm, about 18 nm, about 19 nm, about 20 nm, about 21 nm, about 25 nm, about 30 nm, about 35 nm, about 40 nm, or about 50 nm. The length of the “rod” or “wire” is about 50-100 nm, about 80-500 nm, about 100 nm to 1 μm, about 200 nm to 2 μm, about 300 nm to 3 μm, about 400 nm to 4 μm, about 500 to 5 μm, about 600 nm to 6 μm, about 700 nm to 7 μm, about 800 nm to 8 μm, about 900 nm to 9 μm, about 1 to 10 μm, about 2 to 15 μm, about 3 to 20 μm, or about 5 to 50 μm. Typically, for a metal nanowire disclosed herein (e.g., a Cu-nanowire), the length will be at least 100 nm.

The term “aspect ratio” refers to the ratio of a structure's length to its width. Hence, the aspect ratios of the elongated structures of the disclosure will be greater than one (i.e., length>diameter). In a particular embodiment the aspect ratio, for example, a “wire” is greater than 1, greater than 10, greater than 100, greater than 200, greater than 300, greater than 400, greater than 500, greater than 600, greater than 700, greater than 800, greater than 900, greater than 1,000, greater than 1,500, greater than 2,000, or greater than 5,000. Typically the aspect ratio for a Cu-nanowire of the disclosure will be greater than 100, greater than 200, greater than 300, greater than 400, greater than 500, greater than 600, or greater than 700.

The methods disclosed herein allow for the production of high-quality metal nanowires having various sized diameters in the nanometer range, including wires that have diameters below 50 nm. Nanowires with small diameters generate only a small scattering effect, which is beneficial for transparent conductor applications, while nanowires with larger diameters are more suited for photovoltaics, LEDs, OLEDS, etc., where a large light scattering effect is beneficial. Moreover, the metal nanowires produced by the methods disclosed herein as compared to other candidates for transparent electrodes can be comprised of relatively inexpensive materials. For example, the nanowires can be comprised of copper, which is one of the most earth-abundant metal elements with excellent electrical properties. Additionally, methods to produce the metal nanowires can be solution-based, which is readily scalable and does not require a specially designed reaction chamber with ultra-high vacuum, temperature or delicate plasma control. Moreover, the methods disclosed herein can be easily adapted to allow for size control and controlled growth for a variety of metal-based nanowires other than copper. For example, silver, gold, aluminum, zinc, nickel, tin, iron, vanadium, titanium, and platinum-based nanowires can be synthesized using the methods disclosed herein. Moreover, the methods disclosed herein are generally applicable and can also be used to produce rGO coated-semiconductor-based nanowires, such as rGO coated silicon and germanium nanowires.

For the solution-based methods disclosed herein, the synthesis reaction comprises a metal containing precursor compound, typically a metal containing salt. Any number of metal salts are compatible with the methods disclosed herein, including copper based salts, like Cu(I)I, Cu(I)Br, Cu(I)Cl, Cu(I)F, Cu(I)SCN, Cu(II)Cl₂, Cu(II)Br₂, Cu(II)F₂, Cu(II)OH₂, Cu(II)D-gluconate, Cu(II)MoO₄, Cu(II) (NO₃)₂, Cu(II) (ClO₄)₂, Cu(II) P₂O₇, Cu(II)SeO₃, Cu(II)SO₄, Cu(II)tartrate, Cu(II)(BF₄)₂, Cu(II)(NH₃)₄SO₄, and any hydrates of the foregoing; gold based salts, like Au(I)I, Au(I)Cl, Au(III)Cl₃, HAu(III)Cl₄, Au(III)Br₃, HAu(III)Br₄, Au(III)OH₃, K(Au(III)CL₄) and any hydrates of the foregoing; silver based salts, like Ag(I)BrO₃, Ag₂(I)CO₃, Ag(I)ClO₃, Ag(I)Cl, Ag₂(I)CrO₄, Ag(I)citrate, Ag(I)OCN, Ag(I)CN, Ag(I)cyclohexanebutyrate, Ag(I)F, Ag(II)F₂, Ag(I)lactate, Ag(I)NO₃, Ag(I)NO₂, Ag(I)CLO₄, Ag₃(I)PO₄, Ag(I)BF₄, Ag₂(I)SO₄, Ag(I)SCN, and any hydrates of the foregoing; aluminum based salts, like AlI₃, AlBr₃, AlCl₃, AlF₃, Al(OH)₃, Al-lactate, Al(PO₃)₃, AlO₄P, AL₂(SO₄)₃, and any hydrates of the foregoing; zinc based salts, like ZnI₂, ZnBr₂, ZnCl₂, ZnF₂, Zn(CN)₂, ZnSiF₆, ZnC₂O₄, Zn(ClO₄)₂, Zn₃ (PO₄)₂, ZnSeO₃, ZnSO₄, Zn(BF₄)₂, and any hydrates of the foregoing; nickel based salts, like NiI₂, NiBr₂, NiCl₂, NiF₂, (NH₄)₂Ni(SO₄)₂, Ni(OCOCH₃)₂, NiCO₃, NiSO₄, NiC₂O₄, Ni(ClO₄)₂, Ni(SO₃NH₂)₂, K₂Ni(H₂IO₆)₂, K₂Ni(CN)₄, and any hydrates of the foregoing; and platinum based salts, like Pt(II)Br₂, Pt(II)Cl₂, Pt(II)(CN)₂, Pt(II)I₂, Pt(II)(NH₃)₂Cl₂, Pt(IV)Cl₄, H₂Pt(IV)(OH)₆, H₂Pt(IV)Br₆, Pt(IV)(NH₃)₂CL₄, and including any hydrates of the foregoing, (wherein (I) indicates a +1 oxidation state, (II) indicates a +2 oxidation state, (III) indicates a +3 oxidation state, and (IV) indicates a +4 oxidation state, respectively, for the metal ion).

In a particular embodiment, the solution-based methods of the disclosure utilize a reducing reagent and surface ligand(s) which selectively controls the morphology and size of the resulting metal nanowire products. In a further embodiment, the methods of the disclosure utilize a silane-based reducing agent. Examples of silane-based reducing agents include, but are not limited to, trietylsilane, trimethylsilane, triisopropylsilane, teiphenylsilane, tri-n-propylsilane, tri-n-hexylsilane, triethoxysilane, tris(trimethylsiloxy)silane, tris(trimethylsilyl)silane, di-tert-butylmethylsilane, diethylmethylsilane, diisopropylchlorosilane, dimethylchlorosilane, dimethylethoxysilane, diphenylmethylsilane, ethyldimethylsilane, ethyldichlorosilane, methyldichlorosilane, methyldiethoxysilane, octadecyldimethylsilane, phenyldimethylsilane, phenylmethylchlorosilane, 1,1,4,4-tetramethyl-1,4-disilabutane, trichlorosilane, dimethylsilane, di-tert-butylsilane, dichlorosilane, diethylsilane, diphenylsilane, phenylmethylsilane, n-hexylsilane, n-octadecylsilane, n-octylsilane, and phenylsilane. In yet a further embodiment, the methods disclosed herein utilizes a metal containing precursor compound and silane-based reducing agent at a defined molar ratio. For example, the molar ratio between the metal containing precursor compound to silane-based reducing agent is in the range of 1:100 to 100:1, 1:50 to 50:1, 1:30 to 30:1, 1:20 to 20:1, 1:10 to 10:1, 1:5 to 5:1, 1:4 to 4:1, 1:3 to 3:1, 1:2 to 2:1, 2:3 to 3:2, or about 1:1.

In another embodiment, the methods disclosed herein to produce metal nanowires comprise a surface ligand that also functions as a solvent for the synthesis reaction. Examples of surface ligands include, but are not limited to, oleylamine, trioctylphosphine oxide (TOPO), oleic acid, 1,2-hexadecanediol, trioctylphosphine (TOP), or any combination of the foregoing. Alternatively, the methods disclosed herein can comprise a surface ligand and one or more organic nonpolar solvents. Examples of organic nonpolar solvents include, but are not limited to, toluene, pentane, cyclopentane, hexane, cyclohexane, heptane, ligroin, benzene, 1,4-dioxane, chloroform, carbon tetrachloride, diethyl ether, dichloromethane, xylene, methyl-tert-butyl ether, or a mixture of any of the foregoing.

By varying the reaction conditions, such as the temperature at which the reaction takes place, the amount of starting metal precursor compound, choice of silane based reducing agent, additional solvents, etc. can all affect the structural properties, such as the diameter, length and shape, of the resulting nanowires. For example, it was found that by slowly heating and maintaining a reaction mixture at 160° C. generated Cu-nanowires that had diameters of 19±2 with an aspect ratio greater than one. By changing the reaction temperature, it could be expected that the diameters of the resulting Cu-nanowire may also change. Accordingly, the methods disclosed herein can be run at room temperature or at an elevated temperature, wherein the heating may be performed with a controlled ramp (e.g., 0.5° C., 1° C., 1.5° C., 2° C., 2.5° C., 3° C., 4° C., or 5° C. per minute). In a particular embodiment, the methods of the disclosure are performed at a temperature between about 20° C. to 360° C., about 30° C. to 300° C., about 50° C. to 250° C., about 80° C. to 220° C., about 100° C. to 200° C., about 120° C. to 180° C., or about 140° C. to 170° C. In another embodiment, the methods disclosed herein may be maintained at a set temperature or at various temperatures for a suitable period of time to allow for product formation. For example, depending upon the identity and/or concentration of starting materials, the reaction temperature, etc. the reactions may be maintained at temperature for as little as a few minutes to more than 24 hours. In a particular embodiment, the reaction may be maintained at a temperature(s) for at least 30 minutes, at least 1 hour, at least 2 hours, at least 3 hours, at least 4 hours, at least 5 hours, at least 6 hours, at least 7 hours, at least 8 hours, at least 9 hours, at least 10 hours, at least 12 hours, at least 16 hours, or at least 24 hours. In an alternate embodiment, the reaction may be maintained at a temperature(s) between 1 to 48 hours, between 1 to 24 hours, between 3 to 12 hours, between 4 to 9 hours, between 5 to 8 hours; or about 5 hours, about 6 hours, about 7 hours, about 8 hours, about 9 hours, about 10 hours, or about 12 hours.

In certain embodiments herein, the disclosure further provides methods for the production of graphene oxide nanosheets that can then be used to coat or wrap around the nanowires in order to form a metal nanowire core and graphene oxide shell. The structure and properties of graphene oxide nanosheets depend on the particular synthesis method used and degree of oxidation. Graphene oxide is hydrophilic and easily hydrated when exposed to water vapor or immersed in liquid water or other polar solvents, e.g. alcohols. Typically, graphene oxide is made using Hummers method or Brodie's method, or variations thereof. Examples of such methods that can be used to make the graphene oxide nanosheets described herein, include those described in Sun et al. (“Large scale preparation of graphene quantum dots from graphite with tunable fluorescence properties,” Phys. Chem. Chem. Phys. 15:9907-9913 (2013)); Marcano et al. (“Improved Synthesis of Graphene Oxide”, ACS Nano, 4(8):4806-4814 (2010)); and Chen et al. (“An improved Hummers method for eco-friendly synthesis of graphene oxide”, Carbon 64:225-229 (2013)). In a particular embodiment, a method to produce graphene oxide nanosheets comprises first heating graphite at an elevated temperature (e.g., 40° C.) in the presence of strong oxidants (e.g., H₂SO₄ and KMnO₄, and optionally NaNO₃) under stirring, and then heating at much higher temperature (e.g., the reflux temperature of the solvent) under stirring, to yield graphene oxide.

In further embodiments, the disclosure provides methods to mix and wrap or coat the graphene oxide nanosheets around the metal nanowires of the disclosure. It was found that the mixing and wrapping processes can effectively occur using mild ultra-sonication in a solvent system that comprises a nonpolar organic solvent (e.g., toluene) and a polar solvent (e.g., an alcohol). Accordingly, the hydrophilic GO nanosheets can be diluted with a polar solvent and added to the metal nanowires in a nonpolar organic solvent. The ratio of the metal nanowires to graphene oxide nanosheets can be modified to tune the coverage and shell thickness of the resulting metal-GO core-shell NWs. In a particular embodiment, the ratio of graphene oxide nanosheets to metal nanowires (wt:wt) is 1:20 to 20:1, 1:15 to 15:1, 1:10 to 10:1, 1:5 to 5:1, 1:4 to 4:1, 1:3 to 3:1, 1:2 to 2:1, 1.5:1 to 1:1.5, or about 1:1. The coated nanowires can then be purified by washing (e.g., 2× isopropanol) and centrifugation.

In alternate embodiments, the disclosure also provides methods to wrap graphene nanoribbons (GNRs) around the metal nanowires of the disclosure to form a graphene shell. Examples of such methods include adding the metal nanowires to an aqueous dispersion of GNRs and agitating the mixture (e.g., sonication). The GNRs wrap around the metal nanowires via an electrostatic absorption process. The ratio of the metal nanowires to GNRs can be modified to tune the coverage and shell thickness of the resulting metal-graphene core-shell NWs. In a particular embodiment, the ratio of GNRs to metal nanowires (wt:wt) is 1:20 to 20:1, 1:15 to 15:1, 1:10 to 10:1, 1:5 to 5:1, 1:4 to 4:1, 1:3 to 3:1, 1:2 to 2:1, 1.5:1 to 1:1.5, or about 1:1. The coated nanowires can then be purified by washing and centrifugation.

In certain embodiments, the disclosure also provides for fabricating a conducting nanowire network film comprising the metal-GO or graphene core-shell NWs disclosed herein. The metal-GO or graphene core-shell NWs are diluted in a solvent and ultrasonicated to generate a homogenous suspension. The suspension is then dispersed onto a nonabsorbent porous membrane (e.g., polytetrafluoroethylene porous membrane) using vacuum filtration. The resulting GO-nanowire or graphene-nanowire network can then be transferred to a substrate, e.g., glass, an annealed at an elevated temperature (e.g., 200° C. to 260° C.). In a particular embodiment, the GO-nanowire or graphene-nanowire network is annealed at around 260° C. In a particular embodiment, the GO-nanowire network is annealed under a reducing atmosphere (e.g., 10% Hydrogen gas in argon) at temperature sufficient to thermally reduce the GO to rGO (e.g., 260° C. to 300° C.). In alternate embodiments, other methods can be employed to anneal and reduce GO, including the use of chemical agents, such as hydrazine, lithium naphthalenide, sodium naphthalenide, potassium naphthalenide, thiourea dioxide, NaHSO₃, sodium borohydride, lithium aluminum hydride, thiophene, and ascorbic acid; and the use of light (i.e., photothermal reduction). In regards to the latter method, graphene oxide has been shown to be efficiently reduced using infrared irradiation, as well as light from other portions of the electromagnetic spectrum (e.g., near infrared region). The resulting annealed nanowire network film is characterized by having long term stability when exposed to air; having high percent light transmittance at 550 nm (e.g., between 80 to 99% transmittance); and having small sheet resistance (e.g., between 15 to 40 Ohms/sq).

The disclosure further provides a conducting electrode comprising the conducting nanowire network film disclosed herein. In a further embodiment, the conducting electrode is a transparent conducting electrode. In yet a further embodiment, the conducting electrode is used in optoelectronic devices, such as displays (e.g., LCD, LED and OLED), light sources (e.g., LED diodes and OLED diodes), photovoltaic devices, touch panels, and electrochromic windows. In a particular embodiment, solar cells and/or photodetectors comprise a conducting electrode disclosed herein.

The following examples are intended to illustrate but not limit the disclosure. While they are typical of those that might be used, other procedures known to those skilled in the art may alternatively be used.

### Examples

Materials:

All the chemicals used herein were purchased from Sigma-Aldrich (Sigma-Aldrich, St. Louis Mo.) and used as received.

Ultra-Thin Copper Nanowire Synthesis:

CuCl₂ (0.5 mmol; 85 mg) and oleylamine (5 g) were mixed in a reaction vessel. The mixture was sonicated at ambient temperature until it became clear blue solution. Upon addition of tris(trimethylsily)silane (2 mmol; 0.5 g) as a reducing regent, the reactor was slowly heated up to about 120-160° C. (2° C./min). The reaction was maintained at about 160-165° C. for 8-10 h under stirring. The color of the solution turned a light orange and further into reddish brown, indicating the formation of copper nanowires. The product was harvested by centrifugation at 6000 rpm for 5 min. The nanowires were then washed repeatedly with hexanes using centrifugation-redispersion cycles to remove excess oleylamine. The product was dispersed in toluene for further characterization and further fabrication.

Ultra-Thin Gold Nanowire Synthesis.

To synthesize a gold nanowire, HAuCl₄ is used as gold source and oleylamine is added as a ligand. Triethylsilane is chosen as the reducing regent instead of tris(trimethylsily)silane given the higher activity of gold precursor. After performing the reaction at room temperature for 10 hours, Au nanowires with a mean diameter of around 3 nm are obtained

Graphene Oxide Nanosheet Synthesis:

Graphene oxide nanosheets with a diameter of ˜10 nm were synthesized using the method taught by Sun et al. (“Large scale preparation of graphene quantum dots from graphite with tunable fluorescence properties,” Phys. Chem. Chem. Phys. 15:9907-9913 (2013)).

Cu GO Core-Shell Nanowire Preparation:

A graphene oxide nanosheet aqueous solution (1 mg/mL, 0.5 mL) was diluted in 20 mL methanol. To this diluted GO solution, a Cu nanowire toluene suspension (2 mg/mL, 2.5 mL) was added under stirring. The mixture was ultrasonicated for 3 min to form the copper-graphene oxide core-shell nanowires. The nanowires were separated by centrifugation at 10000 rpm for 10 min. The nanowires were then washed twice with isopropanol using centrifugation-redispersion cycles to remove excess graphene oxide and impurities. The purified copper-graphene oxide core-shell nanowires were dispersed in 3 mL isopropanol for storage. To tune the coverage and shell thickness of the resulting core-shell nanowires, the ratio of the copper nanowires and graphene oxide can be modified.

Conducting Film Fabrication:

To make a conductive thin film, Cu nanowires were diluted using isopropanol by 100 times and ultrasonicated for 5 min to form a homogenous suspension. The thin film was constructed by filtering down the nanowires from the dispersion onto a polytetrafluoroethylene porous membrane (Sartorius Stedim Biotech, pore size 450 nm) via vacuum filtration. The nanowire network was transferred on to a piece of glass by applying pressure to the backside of the membrane and forcing an intimate contact with the substrate. Then, the copper nanowire thin film was annealed under forming gas at various temperatures for 30 min to improve junction contact.

Structural and Electrical Characterizations:

The structural properties of the core-shell nanowires were examined using transmission electron microscope (FEI TitanX 60-300), high-resolution transmission electron microscopy (FEI Tecnai G20), fourier transform infrared spectroscopy, and scanning electron microscope (SEM, JOEL JSM—6340F). Sheet resistance of nanowire thin film was measured using four-point probe method (CDE-RESMAP-270). The transmittance and haze measurement was carried out on a Shimadzu UV-2550 ultraviolet-visible near-infrared spectrophotometer with an integrating sphere.

Strategy for Graphene Oxide Wrapping Copper Nanowires and Film Fabrication.

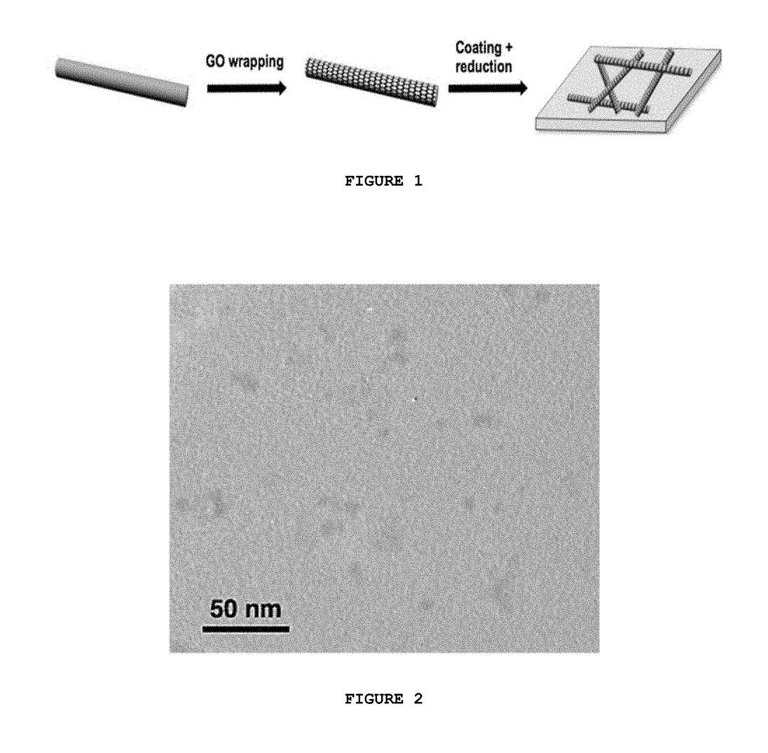

An illustration of the overall strategy of GO wrapping and film fabrication is provided in FIG. 1. Copper nanowires (Cu NWs) with an average diameter of ˜17 nm were synthesized according to the methods described herein. To achieve surface wrapping, graphene oxide (GO) nanosheets with an average diameter of ˜10 nm (see FIG. 2) were synthesized as described herein. The as-synthesized Cu NWs are covered by oleylamine as the surface ligands. Therefore, the NWs can be dispersed in a nonpolar solvent. Examples of nonpolar solvents include, but are not limited to, toluene, pentane, cyclopentane, hexane, cyclohexane, heptane, ligroin, benzene, 1,4-dioxane, chloroform, carbon tetrachloride, diethyl ether, dichloromethane, xylene, methyl-tert-butyl ether, and any mixture thereof. However, GO is not soluble in non-polar solvents. The mixture of Cu NWs and GO nanosheets in solution can be achieved, however, in an “intermediate” solvent. It was found that the mixing and wrapping processes can occur effectively in methanol with mild ultra-sonication. The resulting copper-graphene oxide core-shell nanowires (Cu-GO core-shell NWs) disperse freely in polar solvents (e.g., polar protic solvents and/or polar aprotic solvents). Examples of polar solvents include, polar protic solvents, such as ammonia, formic acid, n-butanol, t-butanol, n-propanol, isopropanol, nitromethane, ethanol, methanol, acetic acid, water, or any mixture of the foregoing; and polar aprotic solvents, such as tetrahydrofuran, ethyl acetate, acetone, dimethylformamide, acetonitrile, dimethyl sulfoxide, or any mixture of the foregoing. The thin native oxide layer (1-3 nm) on Cu surface may have strong interactions with the functional groups on GO and thus provide driving forces for the replacement of oleylamine ligands to GO.

Structural Characterization of the Produced Copper-Graphene Oxide Core-Shell Nanowires by a Variety of Techniques.

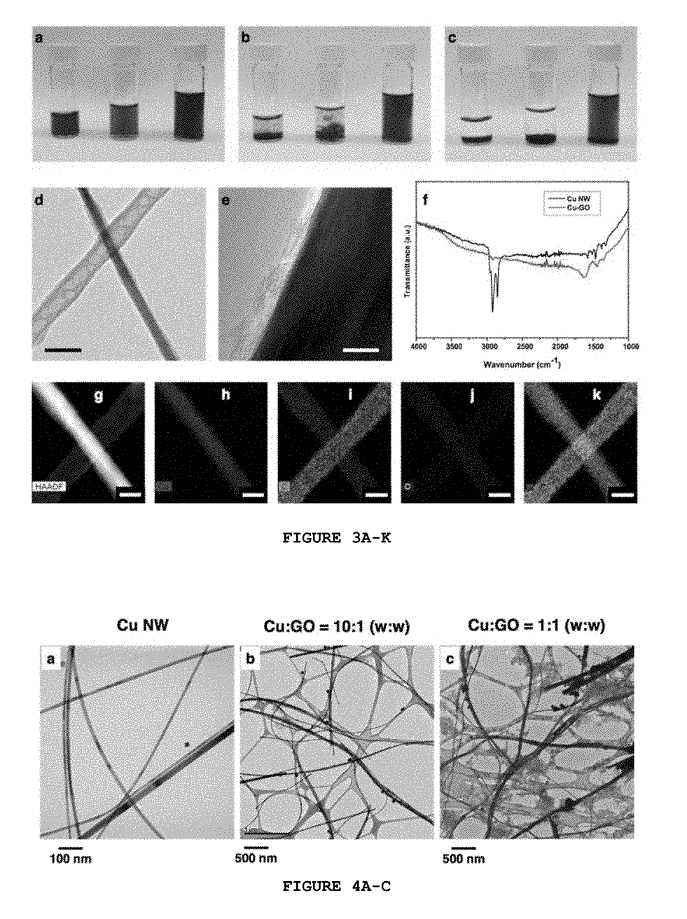

Interestingly, after wrapping, the core-shell NWs form a very stable colloidal suspension in IPA for several days, whereas the as-synthesized Cu NWs aggregate after a few minutes in either toluene or IPA (see FIG. 3A-C). These results provide indirect evidence of successful GO wrapping. The well-dispersed NWs are important to film fabrication because strong aggregation can lead to a larger effective diameter of the wires reducing the performance of NWs by increasing light absorption and scattering. FIG. 3D shows transmission electron microscopy (TEM) images of a GO wrapped Cu NW. It can be seen from the image that a thin layer of GO was coated on the Cu NW with thickness between about 1 to 5 nm. A higher resolution image (see FIG. 3E) indicates a clear interface between the crystalline Cu and amorphous GO. Additional TEM images of the Cu NWs before GO wrapping and with different GO loading amount are shown in FIG. 4A-C. FIG. 3F shows the Fourier transform infrared (FTIR) spectroscopy of the Cu NWs before and after GO wrapping. The signature of oleylamine at 2800˜3000 cm′ becomes negligible, while features of hydroxyl groups (3000˜3500 cm′) and carbon-carbon double bonds of GO (˜1600 cm′) show up for the GO wrapped Cu NWs. Furthermore, the energy-dispersive X-ray spectroscopy mapping on a single wire confirms the proposed core-shell architecture. As shown in FIG. 3G-K, Cu is found only in the core of the wire, while carbon and oxygen elements form a thicker shell around the Cu wire. All these results indicate that the GO nanosheets effectively wrap around the surface of the ultra-thin Cu NWs, without changing the morphology of the Cu NWs.

Strategy to Fabricate the Core-Shell Nanowire Conducting Films on Glass Using a Filtration Method.

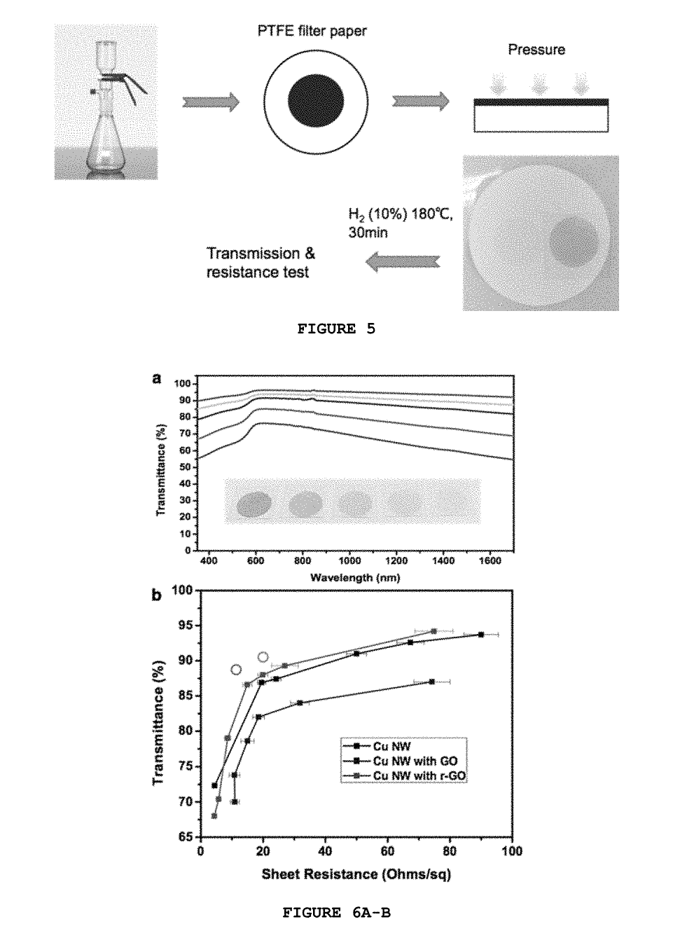

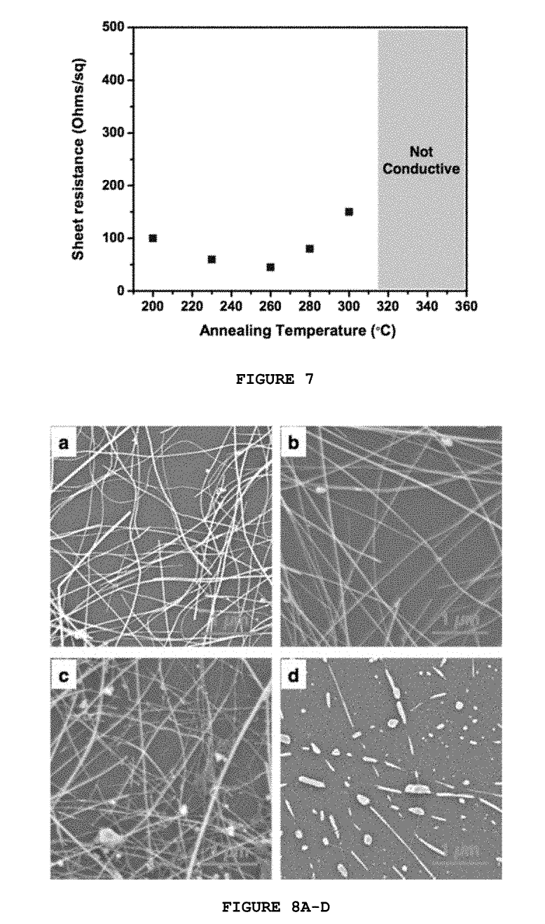

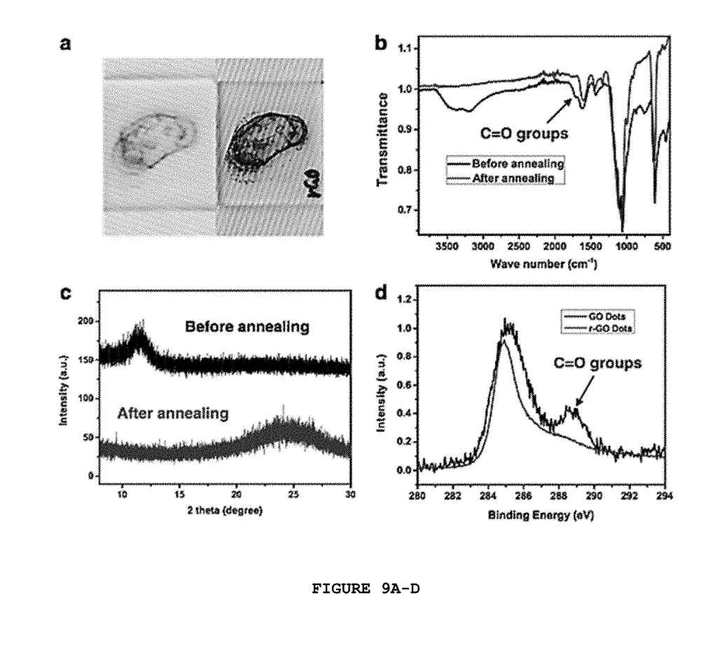

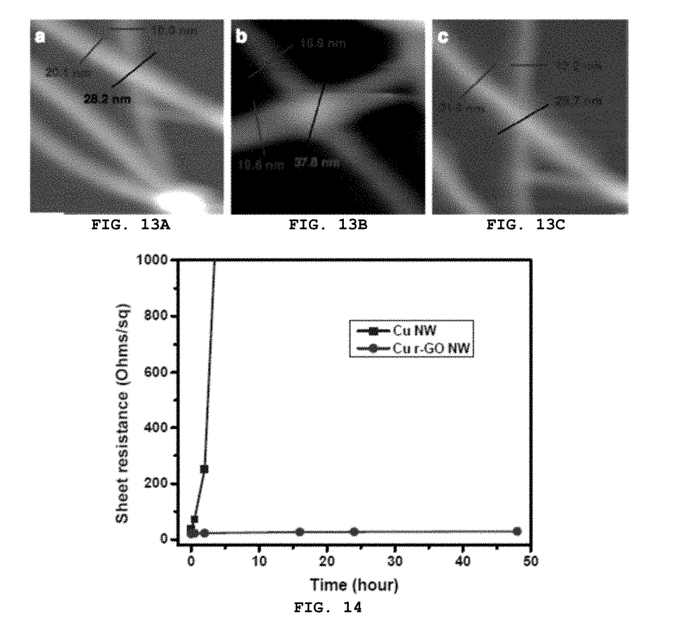

A dilute nanowire suspension in IPA was filtered onto a filter membrane by vacuum. The resulting film was transferred to a glass substrate by pressing the open side of the membrane onto the substrate. The films were then annealed under argon with 10% hydrogen (at 180 or 260° C.) to reduce GO and any residual native copper oxides, and to create a close contact junction between wires. A scheme demonstrating the whole process can be found in FIG. 5. FIG. 6A shows the optical images of the core-shell nanowire transparent films with different loading amount and the corresponding transmittance spectra from UV to near-IR. The films show great transparency from UV-Visible range all the way to infrared, which make them suitable materials for not only display but also for multi-junction photovoltaic cell or thermal applications. FIG. 6B summarizes the transmittance versus the sheet resistance of different types of films. The black and blue curves indicate the performance of the Cu NW films and Cu GO core-shell NW films annealed at 180° C.; respectively. The core-shell NW films show significantly lower performance. GO cannot be thermally reduced at 180° C. GO functions as an insulating layer by preventing efficient charge transfer between individual Cu wires. GO can be effectively reduced under heating at over 250° C. and the reduced GO (r-GO) shows good electric conductivity. The films were annealed at high temperatures (from 200 to 350° C.) in order to improve the performance of the Cu GO core-shell NW transparent conductors by thermally reducing the GO layer. As shown in FIG. 7, the sheet resistance of the core-shell NW film decreases as the annealing temperature increases to around 260° C., and at higher temperature the sheet resistance increases dramatically due to the damage of the Cu NWs. FIG. 8A-D shows the scanning electron microscopy of the films annealed at different temperatures. The nanowire morphology is well preserved at 200 and 260° C. At 300° C., some very thin wires start to melt, and thick bundles of wires (˜100 nm) form. And all the wires melt under 350° C. heating. Note that the Cu NWs without GO coating start to melt at lower temperature (˜230° C.), indicating that the GO wrapped wires have slightly higher melting points and better thermal stability. Under the conditions presented herein, the GO nanosheets can be thermally reduced to form r-GO, as indicated by the color of the power, the FTIR spectra, X-ray diffraction, and X-ray photoelectron spectroscopy studies (see FIG. 9A-D for more details). The morphology of the core-shell NW was checked with high resolution TEM. As shown in FIG. 12A-B, the core-shell structure was well preserved after the thermal annealing. The pink curve in FIG. 6B shows the performance of the high temperature annealed films. Interestingly, they show greatly enhance performance compared to the 180° C. annealed core-shell NW films, and their performance is even slightly better than the naked Cu NW films. For example, sheet resistances of 14.8 Ohms/sq at transparence of 86.5% (wavelength=550 nm), 28.2 Ohms/sq at transparence of 89.3%, and 75.0 Ohms/sq at transparence of 93.9% have been achieved, which are close to the commercial ITO or silver NW transparent electrodes (red and green circles in FIG. 6B). The improvement can be attributed to the following reasons: First, higher temperature can effectively reduce GO and improve the connection and charge transfer between wires. The thickness of individual nanowires and the thickness of the wire-to-wire junctions of the annealed films were measured using atomic force microscopy (AFM) and the results are shown in FIG. 13A-C. The junction thickness was found to be very close to the sum of the thickness of individual wires. These results indicate that the core-shell nanowires likely do not melt together under the optimized annealing condition. Additionally, the r-GO layer facilitates electric conduction from wire to wire, because the thickness of the r-GO layer is very small and the work functions of r-GO and Cu are similar, resulting in an Ohmic contact. Second, the core-shell NWs form a better colloidal suspension, indicating less wire—wire interaction and aggregation. Therefore, during the filtration process, less big bundles form than the Cu NW without GO coating. Third, similar to the graphene wrapped Cu NW case, the r-GO coating may also improve the electric and thermal conductivity of the Cu NWs.

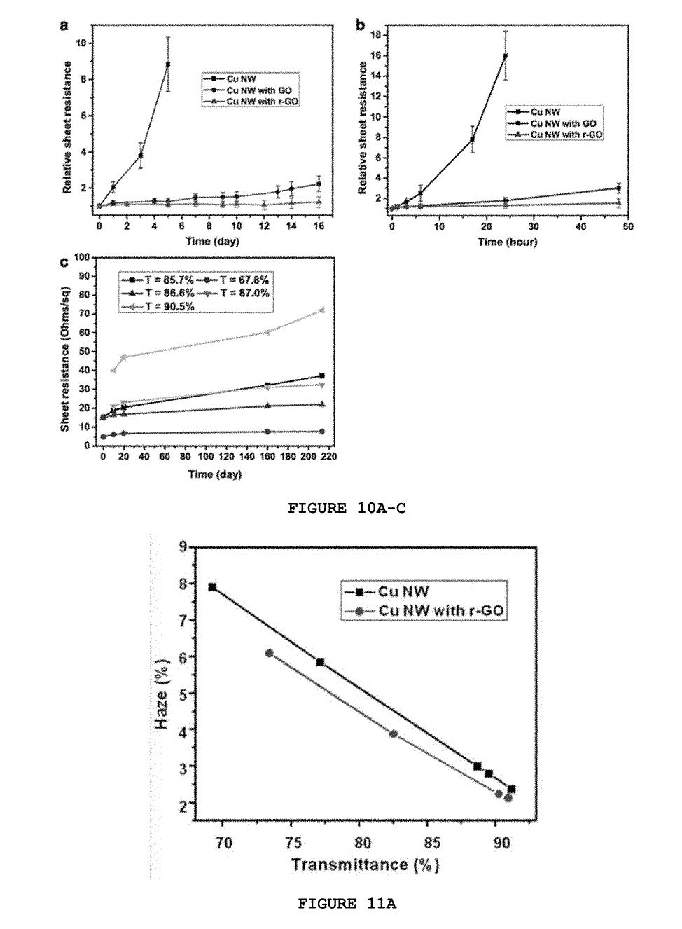

The stability of the transparent films in air was studied to demonstrate the advantages of the GO wrapping approach. Three types of conducting film were recorded: Cu NWs (180° C. annealed), Cu GO core-shell NWs (180° C. annealed), and Cu r-GO core-shell NWs (260° C. annealed). The sheet resistance of 5 films for each type at both room temperature and 80° C. (humidity=40±10%) were recorded and the average values are summarized in FIG. 10A-C. The Cu NW films show poor stability and degraded in a few days at room temperature and in a few hours at 80° C. When wrapped with GO and annealed at 180° C., the stability improved significantly. The sheet resistance of the Cu GO core-shell NW films doubled after two weeks at room temperature and 2 days at 80° C. The Cu r-GO core-shell NW films show even better stability and no obvious degradation was observed, indicating the r-GO wrapping can effectively prevent Cu NW oxidation. The stability in high humidity and high temperature environment were also examined (temperature=80° C., humidity=80±5%) and the results are shown in FIG. 14. The Cu r-GO core-shell NW films show no obvious degradation after 48 h, while the Cu NW films degraded in 2 h. The slight improvement after the thermal reduction is probably due to the enhanced packing of r-GO nanosheets, which limits the diffusion of oxygen molecules through the protecting layer. FIG. 10C shows the absolute sheet resistance of the Cu r-GO core-shell NW films over 213 days storage in air. All the films show great stability and no obvious degradation was observed.

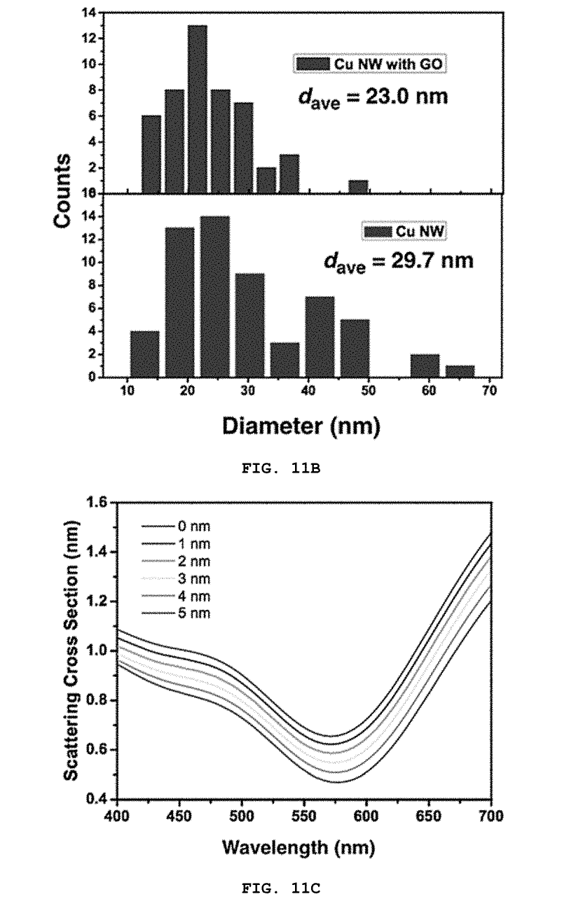

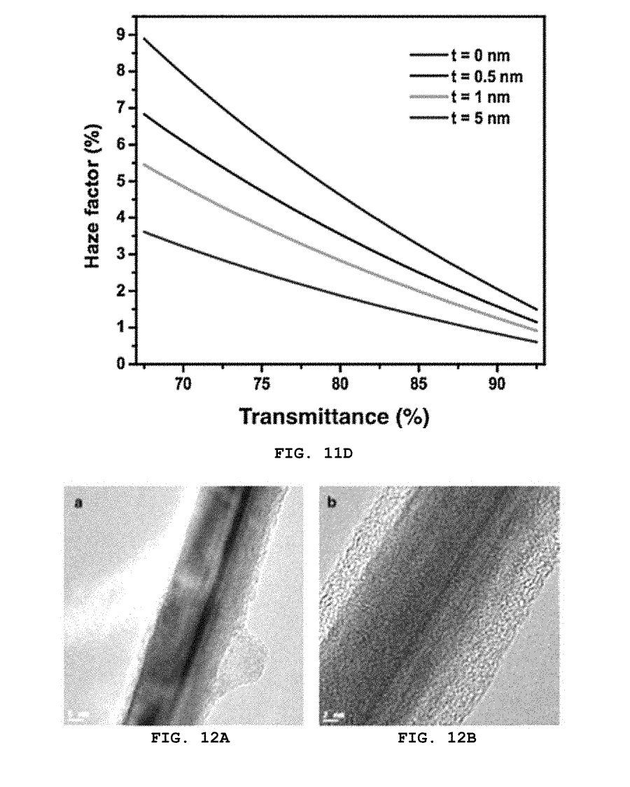

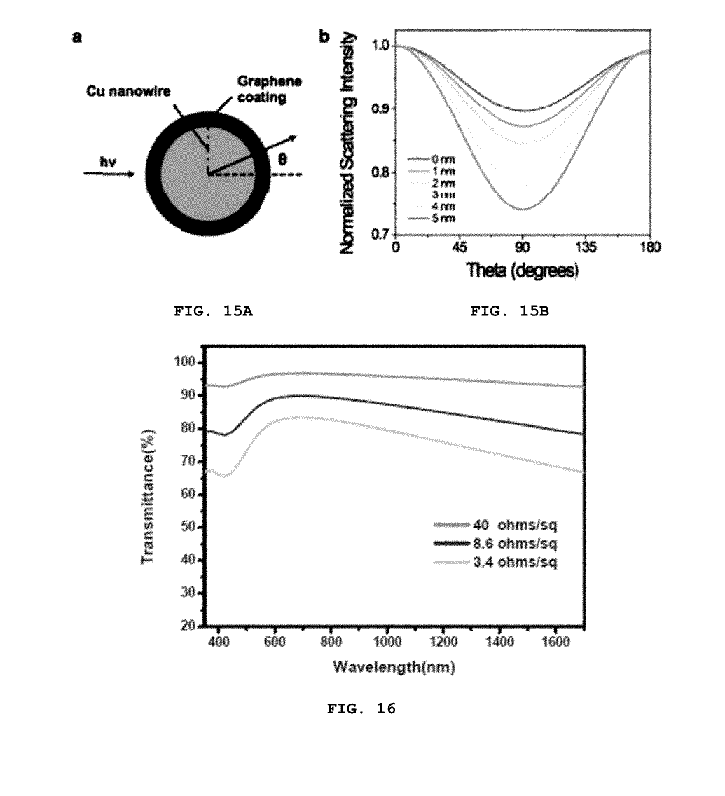

Haze is another important parameter that defines the quality of a transparent electrode. It is defined as the percentage of transmitted light that is scattered through a larger angle than a specified reference angle (e.g., 2.5°) with respect to the direction of the incident beam. It is useful for display applications, in which light scattering will reduce the sharpness of the image and result in a blurred image. The haze of the nanowire mesh conducting film highly depends on the diameter of the nanowire and a previous study showed that our ultrathin Cu NWs can be used to produce conducting thin films with very small haze. Here the Cu r-GO core-shell NW films show even lower haze values compared to the Cu NW films. FIG. 11A shows the haze values of Cu and Cu r-GO NW films at different total transmittance at a wavelength of 550 nm. Clearly, the haze values of the core-shell NW films are 0.5-1% lower than those of the Cu NW films in a large range of total transmittance, indicating the Cu r-GO core-shell NWs have less light scattering effects. This improvement may be the result of two different phenomena. First, wire-wire aggregation in the well-dispersed GO coated nanowires during the filtration process is largely reduced. FIG. 11B shows that the average size of the wire bundles reduced from 29.7 to 23.0 nm in diameter (counted from SEM images of the annealed samples with similar total transmittance, wires were coated with ˜3 nm gold). The thinner wire bundles should reduce the light scattering effect. Second, the r-GO coating introduces a gradual change in refractive index from copper to air, leading to a smaller light scattering cross section for the ultrathin NWs. FIG. 11C shows the optical simulation results of a 17 nm thick Cu nanowire coated with a thin graphene layer which indicate that the light scattering cross section in the visible region is reduced. This is because the carbon has an intermediate refractive index (r=2.3 at 550 nm) between air (r=1.0 at 550 nm) and copper (r=3.3 at 550 nm) and such refractive index gradient decreases the portion of scattered light at higher angles (see FIG. 15 for the simulations on the angle-dependent light scattering of the NWs).

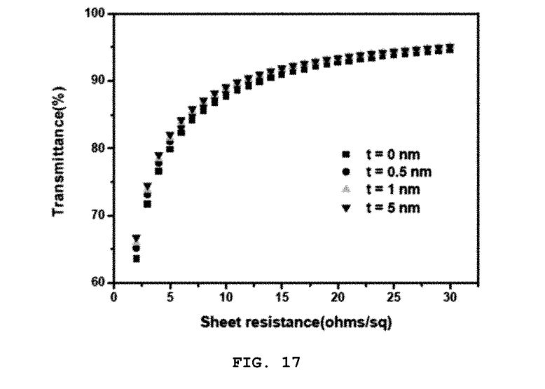

A method was used to model the transmission, haze, and sheet resistance of the core-shell nanowire meshes using Mie theory. The calculated haze versus transmission for Cu and Cu r-GO nanowires with different thicknesses of r-GO is shown in FIG. 11D. This calculation shows that graphene coating decreases haze of the conducting films relative to Cu. The reduction in haze is consistent with the experimental data. The results imply that the average thickness of r-GO around Cu NW is probably less than 1 nm. We also simulate the transmittance spectra (FIG. 16) and transmission versus sheet resistance (FIG. 17) for the core-shell nanowire films, which are also in excellent agreements with the experimental results.

A number of embodiments have been described herein. Nevertheless, it will be understood that various modifications may be made without departing from the spirit and scope of this disclosure. Accordingly, other embodiments are within the scope of the following claims.

1. A method to synthesize nanowires comprising a metal nanowire core and a graphene oxide or graphene shell, comprising:
adding a solution comprising metal nanowires in a first solvent to a solution comprising graphene oxide nanosheets or graphene nanoribbons in a second solvent in order to form a mixture;
agitating the mixture to form metal nanowires that comprise a shell or coating of graphene oxide or graphene,
wherein the first solvent and the second solvent may be the same solvent or alternatively, different solvents.

2. The method of claim 1, further comprising:
purifying the nanowires by:
(i) dispersing the nanowires in a polar solvent; and
(ii) collecting the nanowires by centrifugation;
wherein steps (i) and (ii) can be repeated one or more times.

3. The method of claim 2, wherein the polar solvent is selected from tetrahydrofuran, ethyl acetate, acetone, dimethylformamide, acetonitrile, dimethyl sulfoxide, ammonia, formic acid, n-butanol, t-butanol, n-propanol, isopropanol, nitromethane, ethanol, methanol, acetic acid, water, and any mixture thereof.

4. The method of claim 2, wherein the nanowires are collected by centrifugation or filtration.

5. The method of claim 1, wherein the metal nanowires comprise diameters between 1 nm up to 1 μm.

6. The method of claim 1, wherein the metal nanowires are comprised of silicon, germanium, copper, aluminum, tin, zinc, nickel, iron, titanium, chromium, vanadium, manganese, cobalt, silver, gold, and platinum.

7. The method of claim 6, wherein the metal nanowires are comprised of copper.

8. The method of claim 7, wherein the copper nanowires have an average diameter between 2 nm to 30 nm.

9. The method of claim 1, wherein the first solvent is a nonpolar solvent.

10. The method of claim 9, wherein the nonpolar solvent is selected from the group consisting of toluene, pentane, cyclopentane, hexane, cyclohexane, heptane, ligroin, benzene, 1,4-dioxane, chloroform, carbon tetrachloride, diethyl ether, dichloromethane, xylene, methyl-tert-butyl ether, and any mixture thereof.

11. The method of claim 1, wherein the graphene oxide nanosheets and graphene nanoribbons have diameters between 2 nm to 50 nm.

12. The method of claim 11, wherein the graphene oxide nanosheets have an average diameter of about 10 nm.

13. The method of claim 1, wherein the second solvent is a polar protic solvent and/or a polar aprotic solvent.

14. The method of claim 13, wherein the polar aprotic solvent is selected from the group consisting of tetrahydrofuran, ethyl acetate, acetone, dimethylformamide, acetonitrile, dimethyl sulfoxide, and any mixture thereof; and wherein the polar protic solvent is selected from ammonia, formic acid, n-butanol, t-butanol, n-propanol, isopropanol, nitromethane, ethanol, methanol, acetic acid, water, and any mixture thereof.

15. The method of claim 14, wherein the solvent is a polar protic solvent which comprises an alcohol.

16. The method of claim 1, wherein the mixture is agitated by using sonication.

17. The method of claim 1, wherein the ratio by weight of metal nanowires to graphene nanosheets or graphene nanoribbons is 1:20 to 20:1.

18. The method of claim 17, where the ratio by weight of metal nanowires to graphene nanosheets or graphene nanoribbons is 1:10 to 10:1.

19. (canceled)

20. The method of claim 1, wherein the method further comprises: reducing the coating of graphene oxide on the nanowire to reduced graphene oxide by using a chemical, thermal, photothermal, or electrochemical reduction process.

21. A nanowire produced by the method of claim 1, characterized by having a diameter less than 50 nanometers and having a coating of graphene oxide, graphene, or reduced graphene oxide of around 0.5 to 10 nm, and wherein the nanowire has an aspect ratio greater than 1.

22. A nanowire comprising:
a core of copper that is 10 to 21 nm in diameter; and
a shell of graphene oxide, reduced graphene oxide, or graphene that is 0.5 to 10 nm in thickness,
wherein the shell is in contact along the length dimension of the copper core and wherein the nanowire has an aspect ratio greater than 1.

23. A method to produce a conducting film of annealed nanowires, comprising:
(A) forming a network of the nanowires of claim 22 on a substrate;
(B) annealing the network of nanowires by using plasma-based approach or by annealing at temperature between 200° C. to 300° C.; and if the coating is graphene oxide then
(C) reducing the annealed network of nanowires in the presence of a graphene oxide reducing agent so as to form a conducting film comprising an annealed network of nanowires comprising a metal nanowire core and a reduced graphene oxide coating, wherein the graphene oxide reducing agent is selected from
(i) a reducing atmosphere comprising hydrogen;
(ii) one or more chemical agents selected from hydrazine, lithium naphthalenide, sodium naphthalenide, potassium naphthalenide, thiourea dioxide, NaHSO₃, sodium borohydride, lithium aluminum hydride, thiophene, and/or ascorbic acid; and/or
(iii) exposure to strong light,
and wherein (B) and (C) can be performed as a single reaction step as opposed to two separate steps, when the annealing is done at temperature between 200 to 300° C. and the reducing agent is (i) or (iii).

24. The method of claim 23, wherein the network of nanowires is formed on a substrate by:
filtering down a dispersion of nanowires onto a polytetrafluoroethylene porous membrane to from a network of nanowires; and
transferring the network of nanowires from the membrane to a substrate by applying pressure to backside of the membrane and forcing intimate contact between the network of nanowires to the substrate.

25. The method of claim 23, wherein the substrate is glass.

26. The method of claim 23, wherein the network of nanowires are annealed at temperature of about 260° C. under an atmosphere comprising argon and hydrogen.

27. A conducting film produced by the method of claim 23.

28. A transparent electrode comprising the conducting film of claim 27.

29. An optoelectronic device comprising the transparent electrode of claim 28.

30. The optoelectronic device of claim 29, wherein the optoelectronic device is selected from the group consisting of a LCD display, a LED display, a photovoltaic device, a touch panel, a solar panel, a light emitting diode (LED), an organic light emitting diode (OLED), an OLED display, and a electrochromic window.
